(19) United States
(12) Patent Application Publication
(10) Pub. No.: US 2025/0300324 A1
(43) Pub. Date: Sep. 25, 2025

(54) BATTERY STACK AND BATTERY PACK

(71) Applicant: TOYOTA JIDOSHA KABUSHIKI KAISHA, Aichi-ken (JP)

(72) Inventor: Junta KATAYAMA, Miyoshi-shi (JP)

(21) Appl. No.: 19/078,284

(22) Filed: Mar. 13, 2025

(30) Foreign Application Priority Data
Mar. 21, 2024 (JP) 2024-045377

(51) Int. Cl. H01M 50/503; H01M 10/48; H01M 10/613; H01M 10/6555

(52) U.S. Cl. CPC H01M 50/503; H01M 10/486; H01M 10/613; H01M 10/6555

(57) ABSTRACT

A battery stack includes: a plurality of battery modules; and conductive members provided on both side of the battery modules in a first direction of the battery modules via an adhesive member including first and second adhesive members. Further, the conductive member, when viewed from a second direction perpendicular to the first direction, includes first and second flat plate portions, and a connecting portion located between the first flat plate portion and the second flat plate portion, the first flat plate portion is located on a battery module side in the first direction than the second flat plate portion, and a Young's modulus of the first adhesive member disposed between the first flat plate portion and the battery module is less than the Young's modulus of the second adhesive member disposed between the second flat plate portion and the battery module.

### CROSS-REFERENCE TO RELATED APPLICATION(S)

The present application claims priority to and incorporates by reference the entire contents of Japanese Patent Application No. 2024-045377 filed in Japan on Mar. 21, 2024.

### BACKGROUND

The present disclosure relates to a battery stack and a battery pack.

Japanese Laid-open Patent Publication No. 2022-175828 discloses a flat current collector plate for collecting current as a module positive electrode and a module negative electrode of the bipolar cell stacked in the first direction.

### SUMMARY

There is a need for providing a battery stack and a battery pack capable of suppressing deformation of the conductive member.

According to an embodiment, a battery stack includes: a plurality of battery modules; and a plurality of conductive members provided on both side of the battery modules in a first direction of the battery modules via an adhesive member including a first adhesive member and a second adhesive member. Further, the conductive member, when viewed from a second direction perpendicular to the first direction, includes a first flat plate portion, a second flat plate portion, and a connecting portion located between the first flat plate portion and the second flat plate portion, the first flat plate portion is located on a battery module side in the first direction than the second flat plate portion, and a Young's modulus of the first adhesive member disposed between the first flat plate portion and the battery module is less than the Young's modulus of the second adhesive member disposed between the second flat plate portion and the battery module.

### BRIEF DESCRIPTION OF THE DRAWINGS

FIG. 1 is a cross-sectional view illustrating a schematic configuration of a battery pack according to a first embodiment;

FIG. 2 is an enlarged view illustrating an enlarged part of the lower portion of the battery stack in the battery pack according to the first embodiment;

FIG. 3 is an enlarged view illustrating an enlarged end portion of the third direction in the lower portion of the battery stack in the battery pack according to a second embodiment; and

FIG. 4 is an enlarged view illustrating an enlarged central portion of the third direction in the lower portion of the battery stack in the battery pack according to the second embodiment.

### DETAILED DESCRIPTION

In the related art, when a plurality of types of adhesive members are used for adhesion between the current collecting plate which is a conductive member and the battery module, and adhesion between the current collecting plate and the case of the battery pack, the Young's modulus differs depending on the adhesive member. Therefore, the vertical stress of the current collecting plate, the battery module, and the case of the battery pack may vary and the current collecting plate may be deformed.

### First Embodiment

Hereinafter, a description will be given of a first embodiment of a battery stack and a battery pack according to the present disclosure. Note that the present disclosure is not limited by the embodiment.

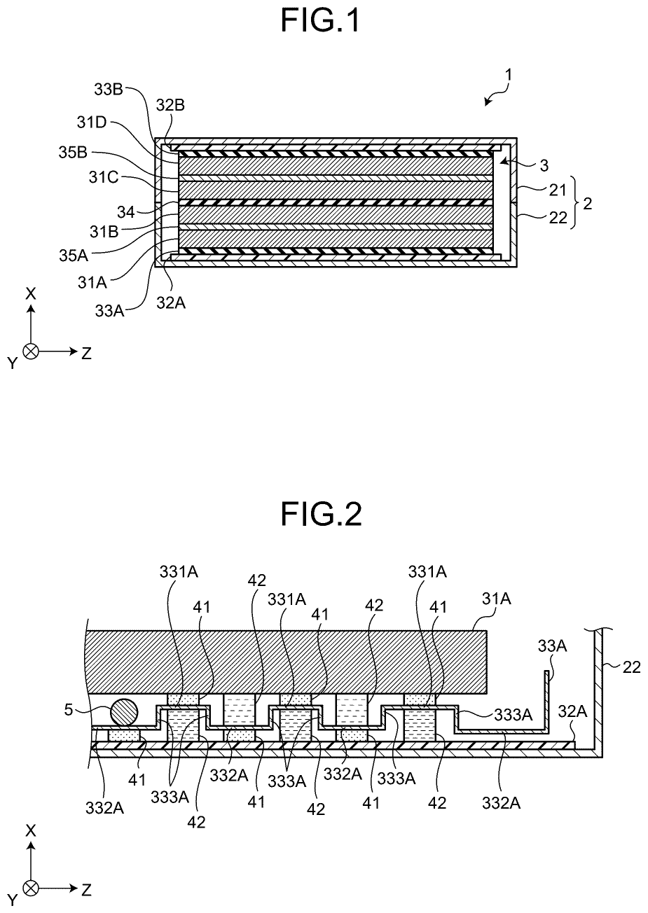

FIG. 1 is a cross-sectional view illustrating a schematic configuration of a battery pack 1 according to the first embodiment.

A battery pack 1 in the first embodiment is mounted on an electric vehicle, for example, a power supply source for supplying power to the motor is a driving source of the electric vehicle. The battery pack 1 according to the first embodiment includes a case 2 constituted by an upper case 21 and a lower case 22. The case 2 houses the battery stack 3 which serves as a storage device. The upper case 21 and the lower case 22 are opposed in the first direction of the battery pack 1 (battery stack 3) (arrow X direction in FIG. 1). Incidentally, the arrow Y direction in FIG. 1 is a second direction perpendicular to the first direction. Further, the arrow Z direction in FIG. 1 is a third direction perpendicular to both the first direction and the second direction.

The battery stack 3 includes a plurality of battery module 31A, 31B, 31C, and 31D, a plurality of current collector plate 33A and 33B, a current carrying plate 34, and a plurality of cooling plates 35A and 35B. The battery stack 3 is a laminate body, in which, from the lower side (lower case 22 side) to the upper side (upper case 21 side) in the first direction, the current collector plate 33A, the battery module 31A, the cooling plate 35A, the battery module 31B, the current passing plate 34, the battery module 31C, the cooling plate 35B, the battery module 31D, the current collector plate 33B are arranged by laminating in this order. That is, in the battery stack 3 according to the first embodiment, it is arranged the current collecting plates 33A and 33B at the bottom and the top of the battery stack 3, respectively, in the stacking direction of the battery modules 31A, 31B, 31C, and 31D (battery stack 3). Further, in the battery stack 3 according to the first embodiment, between the battery modules 31B and 31C adjacent to each other in the stacking direction, a current-carrying plate 34 is arranged. Further, in the cell stack 3 according to the first embodiment, the cooling plates 35A and 35B are arranged between the cell modules 31A and 31B adjacent to each other in the stacking direction and between the cell modules 31C and 31D adjacent in the stacking direction, respectively.

Each of the battery modules 31A, 31B, 31C, and 31D has a plurality of battery cells. Each of the battery cells is composed of, for example, a lithium-ion battery or a bipolar electrode body or a monopolar electrode body or the like. The number of battery modules of the battery stack 3 according to the first embodiment is not limited to four of the battery module 31A, 31B, 31C, and 31D.

The current collector plate 33A and the current collector plate 33B are a positive current collector plate and a negative current collector plate, respectively, serving as a conductive member electrically connected to adjacent cell modules 31A and 31D. Further, the current-carrying plate 34 is electrically connected between the battery-modules 31B and 31C. Further, the cooling plates 35A and 35B are formed of a metal such as aluminum or copper, and electrically connect between the battery modules 31A and 31B and between the battery modules 31C and 31D, respectively.

In the battery pack 1 according to the first embodiment, an insulating sheet 32A which is a plate-like insulating member is disposed between the lower case 32 and the current collecting plate 33A. Further, between the upper case 31 and the current collecting plate 33B, the insulating sheet 32B, which is a plate-shaped insulating member, is disposed.

FIG. 2 is an enlarged view illustrating an enlarged part of the lower portion of the battery stack 3 in the battery pack 1 according to the first embodiment.

As illustrated in FIG. 2, in the battery pack 1 according to the first embodiment, the current collecting plate 33A is disposed at the lower end of the battery module 31A in the first direction through the adhesive member (a first adhesive member 41 or a second adhesive member 42). The thickness of the current collecting plate 33A, for example, is about 0.5 mm to 3.4 mm.

The current collecting plate 33A, as viewed from the second direction, has a first flat plate portion 331A, a second flat plate portion 332A, and a connecting portion 333A located between the first flat plate portion 331A and the second flat plate portion 332A. The first flat plate portion 331A is located on the cell module 31A side in the first direction than the second flat plate portion 332A. The distance between the first flat plate portion 331A and the cell module 31A in the first direction is, for example, 1 mm to 2 mm. Further, the distance between the second flat plate portion 332A and the battery module 31A in the first direction is, for example, 1 mm to 2 mm.

In the battery pack 1 according to the first embodiment, the first adhesive member 41 is disposed between the first flat plate portion 331A of the current collecting plate 33A and the battery module 31A to adhere the first flat plate portion 331A and the battery module 31A. Further, in the battery pack 1 according to the first embodiment, the second adhesive member 42 is disposed between the second flat plate portion 332A of the current collecting plate 33A and the battery module 31A to adhere the second flat plate portion 332A and the battery module 31A.

The first adhesive member 41 is, for example, an epoxy-based conductive adhesive having high conductivity than the second adhesive member 42. The second adhesive member 42 is, for example, an epoxy-based thermally conductive adhesive having high thermal conductivity than the first adhesive member 41. Further, the thickness of the first adhesive member 41 is thinner than the thickness of the second adhesive member 42. Thus, it is possible to increase the conductivity by reducing the electric resistance between the first flat plate portion 331A and the battery module 31A through the first adhesive member 41. On the other hand, the thickness of the second adhesive member 42 is greater than the thickness of the first adhesive member 41, it is possible to have a strength in the fixing of the second flat plate portion 332A and the battery module 31A by the second adhesive member 42.

Spacing between the first adhesive member 41 and the second adhesive member 42 in the third direction is, for example, 0 mm or more and 10 mm or less. The length of the width direction of the first adhesive member 41 and the second adhesive member 42 (the direction of alignment between the first adhesive member 41 and the second adhesive member 42) is, for example, 3 mm or more and 20 mm or less.

Then, in the battery pack 1 according to the first embodiment, the first adhesive member 41 has smaller Young's modulus than the second adhesive member 42. Thus, it is possible to suppress the deformation of the current collecting plate 33A caused because the compressive load required by the first adhesive member 41 and the second adhesive member 42 is different. Further, to increase the distance between the second adhesive member 42 having relatively large Young's modulus and hardly deformed and the battery module 31A, it is possible to suppress the deformation due to uneven normal stress to the current collecting plate 33A.

Further, since the connecting portion 333A of the current collecting plate 33A extends in the first direction, it is possible to suppress the spread of the second adhesive member 42 located between the second flat plate portion 332A and the battery module 31A in the second direction.

Further, in the battery pack 1 according to the first embodiment, the collector plate 33A is disposed on the lower case 22 through the first adhesive member 41 or the second adhesive member 42 in a direction away from the battery module 31A in the first direction and the insulating sheet 32A. The first adhesive member 41 located between the first flat plate portion 331A of the current collecting plate 33A and the insulating sheet 32A has a smaller Young's modulus than the second adhesive member 42 located between the second flat plate portion 332A of the current collecting plate 33A and the insulating sheet 32A. Thus, it is possible to suppress the deformation of the collector plate 33A and the battery module 31A caused by different compressive loads required by the first adhesive member 41 and the second adhesive member 42 on both sides present in the first direction of the current collector plate 33A.

Further, in the battery pack 1 according to the first embodiment, at least between the first flat plate portion 331A and the insulating sheet 32A and between the second flat plate portion 332A and the battery module 31A, a thermistor 5, which is a temperature measuring device for measuring the temperature of the battery module 31A may be provided. In FIG. 2, the thermistor 5 is provided between the second flat plate portion 332A and the battery module 31A. Thus, in the battery pack 1 according to the first embodiment, the temperature of the battery module 31A can be measured by the thermistor 5 while suppressing an increase in the total height of the battery pack 1 due to the thickness of the thermistor 5 in the first direction.

### Second Embodiment

Hereinafter, a description will be given of a second embodiment of a battery stack and a battery pack according to the present disclosure. Incidentally, the same configuration as the first embodiment in the second embodiment will not be appropriately described.

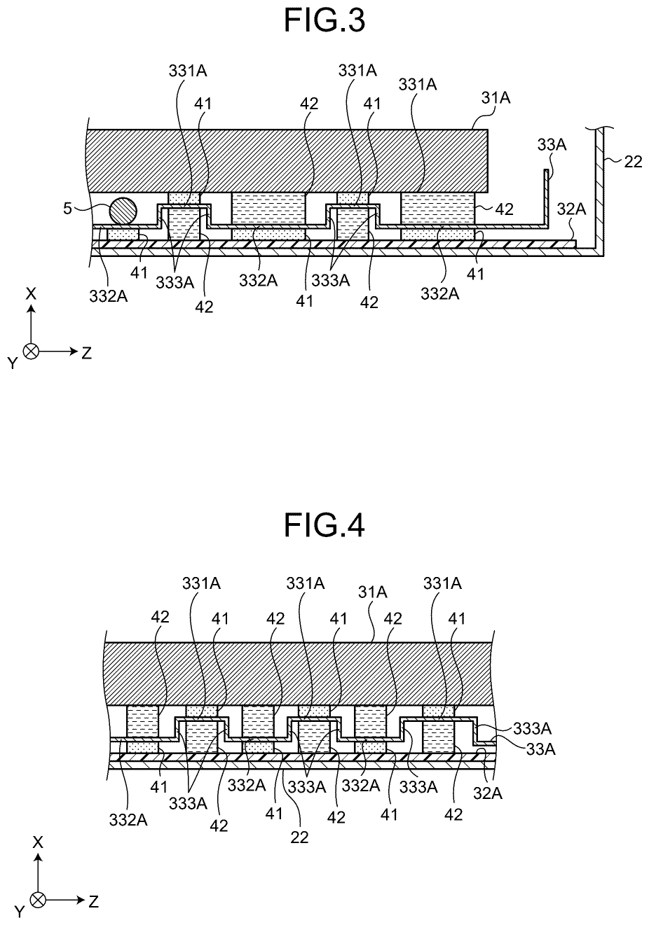

FIG. 3 is an enlarged view illustrating an enlarged end portion of the third direction in the lower portion of the battery stack 3 in the battery pack 1 according to the second embodiment. FIG. 4 is an enlarged view illustrating an enlarged central portion of the third direction in the lower portion of the battery stack 3 in the battery pack 1 according to the second embodiment.

In the battery pack 1 according to the second embodiment, the current collecting plate 33A of the battery stack 3 is configured such that the end portion in the third direction is smaller in bending stiffness than the central portion in the third direction. Specifically, in the battery pack 1 according to the second embodiment, the first flat plate portion 331A or the second flat plate portion 332A of the current collector plate 33A is configured such that the end portion in the third direction is longer than the central portion in the third direction. For example, in FIGS. 3 and 4, the length at the end portion and in the third direction of the second flat plate portion 332A in the current collecting plate 33A is greater than that of the central portion in the third direction.

Thus, in the battery pack 1 according to the second embodiment, among the battery module 31A and the current collector plate 33A, it is possible to improve the follow-up ability of the current collector plate 33A to the battery module 31A at the end of the third direction which is easily separated by vibrations or the like in the first direction. Therefore, in the battery pack 1 according to the second embodiment, at the end of the battery stack 3 in the third direction, the battery pack 1 and the like vibrate in the first direction, thereby preventing the current collecting plate 33A from being separated from the battery module 31A.

Further, in the current collector plate 33A, the length of the connecting portion 333A in the middle portion in the first direction may be greater than the length of the connecting portion 333A in the end portion in the first direction, so that the bending stiffness of the end portion in the third direction is smaller than the bending stiffness in the central portion in the third direction. In this case, in the middle part of the current collecting plate 33A, the distance between the first flat plate portion 331A and the battery module 31A in the first direction is, for example, 3 mm to 4 mm. Further, in the central portion in the third direction in the current collecting plate 33A, the distance between the second flat plate portion 332A and the battery module 31A in the first direction is, for example, 3 mm to 4 mm.

According to an embodiment, it is possible to suppress the deformation of the conductive member caused by the difference in the required compression load between an adhesive member located between the first flat plate portion and the battery module and between the second flat plate portion and the battery module.

According to an embodiment, it is possible to suppress the spread in the second direction of the adhesive member located between the second flat plate portion and the battery module.

According to an embodiment, it is possible to suppress the deformation of the conductive member caused by the difference in the compression load required for the adhesive member on both sides of the conductive member.

According to an embodiment, while suppressing an increase in the total height of the battery pack due to the thickness of the temperature measuring element in the first direction, it is possible to measure the temperature of the battery module by the temperature measuring element.

According to an embodiment, among the battery module and the conductive member, to improve the trackability of the conductive member to the battery module at the end of the third direction easily separated by vibration or the like in the first direction, it is possible to suppress the separation of the conductive member from the battery module.

The battery stack and the battery pack according to the present disclosure has an effect that it is possible to suppress the deformation of the conductive member.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery stack comprising:
a plurality of battery modules; and
a plurality of conductive members provided on both side of the battery modules in a first direction of the battery modules via an adhesive member including a first adhesive member and a second adhesive member, wherein
the conductive member, when viewed from a second direction perpendicular to the first direction, includes a first flat plate portion, a second flat plate portion, and a connecting portion located between the first flat plate portion and the second flat plate portion,
the first flat plate portion is located on a battery module side in the first direction than the second flat plate portion, and
a Young's modulus of the first adhesive member disposed between the first flat plate portion and the battery module is less than the Young's modulus of the second adhesive member disposed between the second flat plate portion and the battery module.

2. The battery stack according to claim 1, wherein
the connecting portion extends in the first direction.

3. A battery pack comprising a case accommodating the battery stack according to claim 1, wherein
the conductive members are disposed on the case via the adhesive member and an insulating member in a direction away from the battery modules in the first direction, and
the Young's modulus of the second adhesive member disposed between the first flat plate portion and the insulating member is less than the Young's modulus of the first adhesive member disposed between second flat plate portion and the insulating member.

4. The battery pack according to claim 3, further comprising a temperature measurement element, provided at least one of between the first flat plate portion and the insulating member and between the second flat plate portion and the battery module, for measuring a temperature of the battery module.

5. The battery pack according to claim 4, wherein
a bending rigidity of an end portion of the conductive members in a third direction perpendicular to both of the first direction and the second direction is less than the bending rigidity of a middle portion of the conductive member in the third direction.
